(19) United States
(12) Patent Application Publication
(10) Pub. No.: US 2022/0055622 A1
(43) Pub. Date: Feb. 24, 2022

(54) VEHICLE SAFETY APPARATUS

(71) Applicant: Toyota Jidosha Kabushiki Kaisha, Toyota-shi Aichi-ken (JP)

(72) Inventors: Daisuke Sato, Susono-shi (JP); Daisuke Ishii, Sunto-gun (JP); Hiroki Izu, Nagoya-shi (JP); Hiroki Morita, Hiratsuka-shi (JP); Kei Sato, Toyota-shi (JP); Masaki Nanahara, Toyota-shi (JP); Kazumi Serizawa, Toyota-shi (JP); Hironobu Tanaka, Shinagawa-ku (JP); Shunsuke Mogi, Hachioji-shi (JP); Takashi Hayashi, Nagoya-shi (JP); Akihiro Kusumoto, Susono-shi (JP)

(21) Appl. No.: 17/407,640

(22) Filed: Aug. 20, 2021

(30) Foreign Application Priority Data
Aug. 24, 2020 (JP) 2020-141174

(51) Int. Cl. B60W 30/18; B60W 40/08

(52) U.S. Cl. CPC B60W 30/18009; B60W 40/08; B60W 2540/227; B60W 2540/223; B60W 2420/42

(57) ABSTRACT

A vehicle safety apparatus mounted on a vehicle includes one or more cameras to detect passenger state information relating to a riding state of a passenger on the vehicle, a memory to store the passenger state information detected by the one or more cameras, and a processor to execute motion control of the vehicle based on the passenger state information stored in the memory. The processor is configured to execute posture determination processing to determine whether the passenger is riding in a stable posture based on the passenger state information, and safety securing processing to secure safety of the passenger by executing the motion control, when the passenger is not riding in the stable posture in the posture determination processing.

### CROSS-REFERENCE TO RELATED APPLICATION

The present application claims priority under 35 U.S.C. § 119 to Japanese Patent Application No. 2020-141174, filed Aug. 24, 2020, the contents of which application are incorporated herein by reference in their entirety.

### BACKGROUND

### Field

The present disclosure relates to vehicle safety apparatus and, in particular, to vehicle safety apparatus for vehicles in which passengers ride standing up.

### Background Art

Japanese Patent Application Laid-Open No. 2016-107817 discloses a technique related to an in-vehicle accident prevention system for preventing an in-vehicle accident. The system of this technology determines the danger in the observation area based on the photographed contents of an omnidirectional camera installed in the car interior, and notifies the alarm according to the determination result.

### SUMMARY

According to the system of Japanese Patent Laying-Open No. 2016-107817, it is possible to notify an alarm to a passenger in accordance with the result of the determination of the danger. However, depending on the degree of hazard, there is still a possibility that notification only by the alarm is insufficient, it is desired to ensure safety from the perspective of vehicle motion.

The present disclosure has been made in view of the above-mentioned problems, and an object thereof is to provide a vehicle safety apparatus capable of ensuring safety of a passenger from the perspective of vehicle motion.

In order to solve the above problems, the first disclosure is applied to a vehicle safety apparatus mounted on a vehicle. The vehicle safety apparatus includes one or more cameras to detect passenger state information relating to a riding state of a passenger on the vehicle, a memory to store the passenger state information detected by the one or more cameras, and a processor to execute motion control of the vehicle based on the passenger state information stored in the memory. The processor is configured to execute posture determination processing to determine whether the passenger is riding in a stable posture based on the passenger state information, and safety securing processing to secure safety of the passenger by executing the motion control, when the passenger is not riding in the stable posture in the posture determination processing.

The second disclosure further includes the following features in the first disclosure.

The posture determination processing includes, a process of calculating a zero moment point of the passenger based on the passenger state information, and a process of determining whether the passenger is riding in the stable posture based on the zero moment point.

The third disclosure further includes the following features in the first disclosure.

The posture determination processing includes, a process of determining whether the passenger is supported by a fixed object of the vehicle based on the passenger state information, and a process of determining that the passenger is riding in the stable posture when the passenger is determined to be supported by the fixed object.

The fourth disclosure further includes the following features in the first disclosure.

The safety securing processing includes stopping or decelerating while the vehicle travels, or suspending starting while the vehicle is stopped.

The fifth disclosure further includes the following features in the first disclosure.

The passenger state information includes facial information relating to facial expressions of the passenger. The posture determination processing includes a process of determining whether the passenger is riding in the stable posture based on the facial information.

The sixth disclosure further includes the following features in the first disclosure.

The passenger state information includes posture information related to a posture of the passenger. The posture determination processing includes a process of determining whether the passenger is riding in the stable posture based on the posture information.

According to the first disclosure, when it is determined that the passenger is not riding in the stable posture, the safety of the passenger is secured by executing the motion control of the vehicle. This makes it possible to secure the safety of the passenger from the perspective of vehicle motion.

According to the second disclosure, based on the passenger's zero moment point (ZMP), it is possible to determine with high accuracy whether the passenger is riding in the stable posture.

According to the third disclosure, when the passenger is supported to a fixed object, it is determined that the passenger is riding in the stable posture. This makes it possible to determine that the passenger is riding in the stable posture when the passenger is supported to the fixed object of the vehicle, such as a handrail or a backrest.

According to the fourth disclosure, when it is determined that the passenger is not riding in the stable posture, it is possible to secure the safety of the passenger by decelerating or stopping the traveling vehicle, or suspending the starting of the stopped vehicle.

According to the fifth disclosure, it is possible to determine whether the passenger is riding in the stable posture based on the facial expression of the passenger.

According to the sixth disclosure, it is possible to determine whether the passenger is riding in the stable posture based on the posture of the passenger.

### BRIEF DESCRIPTION OF DRAWINGS

FIG. 1 is a diagram showing a schematic structure of a vehicle to which a vehicle safety apparatus of a first embodiment is applied;

FIG. 2 is a block diagram for explaining a schematic configuration of a control system of a vehicle according to the first embodiment;

FIG. 3 is a block diagram for explaining functions realized by a controller of the first embodiment;

FIG. 4 is a diagram showing an example of a whole-body image of a passenger used for calculation of ZMP;

FIG. 5 is a diagram showing an example of a stable region Rth of ZMP;

FIG. 6 is a flowchart of a routine in which the controller executes ZMP calculation processing and posture determination processing;

FIG. 7 is a flowchart of a routine in which the controller executes safety securing processing;

FIG. 8 is a flowchart of a routine in which the controller according to the second embodiment executes the posture determination processing;

FIG. 9 is a flowchart of a routine in which the controller according to the third embodiment executes the posture determination processing; and

FIG. 10 is a flowchart of a routine in which the controller according to the fourth embodiment executes the posture determination processing.

### DETAILED DESCRIPTION

Hereinafter, an embodiment of the present disclosure will be described with reference to the accompanying drawings. However, it is to be understood that even when the number, quantity, amount, range or other numerical attribute of each element is mentioned in the following description of the embodiment, the present disclosure is not limited to the mentioned numerical attribute unless explicitly described otherwise, or unless the present disclosure is explicitly specified by the numerical attribute theoretically. Furthermore, structures or steps or the like that are described in conjunction with the following embodiment is not necessarily essential to the present disclosure unless explicitly described otherwise, or unless the present disclosure is explicitly specified by the structures or the like theoretically.

### 1. First Embodiment

### 1-1. Outline of First Embodiment

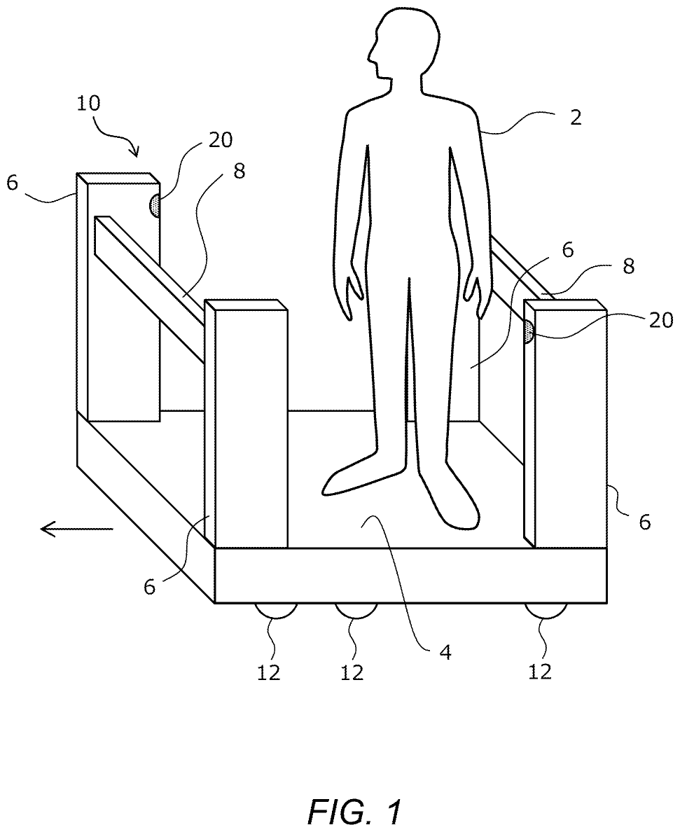

First, an outline of the first embodiment will be described with reference to FIG. 1. A vehicle 10 to which the vehicle safety apparatus according to the present embodiment is applied is a vehicle capable of autonomous driving using map information and sensor information. FIG. 1 is a diagram showing a schematic structure of a vehicle to which a vehicle safety apparatus of the present embodiment is applied. The vehicle 10 can run autonomously without any driving operation by the driver. As the vehicle 10, for example, is a pallet-type small mobility vehicle that is designed to be ridden standing by passengers. Such a vehicle 10 provides a driverless transport service to the passenger 2 on board.

Specifically, the vehicle 10 picks up the passenger 2 at a location designated by the passenger 2 or a predetermined location. Then, the vehicle 10 autonomously travels to a destination designated by the passenger 2 or a predetermined destination. Upon arrival at the destination, the vehicle 10 drops off the passenger 2.

Here, the passenger 2 standing on the vehicle 10 may not always able to maintain a stable posture. Therefore, the vehicle 10 is equipped with a vehicle safety apparatus to ensure the safety of the passenger 2 of the vehicle 10. The vehicle safety apparatus executes a posture determination processing for determining whether the passenger 2 riding on the vehicle 10 is in a stable posture. In the posture determination processing, the zero moment point (ZMP) of passenger 2 is utilized. ZMP is a point where the inertial force of the body of passenger 2 and the floor reaction force acting on the sole of the foot are balanced. The calculation of the ZMP uses information detected by one or more internal cameras 20 for imaging the riding posture of the passenger 2. This information is called “passenger state information” because it is information relating to the riding state of the passenger 2. The vehicle safety apparatus determines whether the riding posture of the passenger 2 is stable according to whether the calculated ZMP belongs to a prescribed stable region. The stable region is set to, for example, a predetermined region included inside a support polygon defined from the region of the right and left soles.

When it is determined that the passenger 2 is in an unstable posture while the vehicle 10 is traveling, the vehicle safety apparatus stops or decelerates the vehicle 10. Alternatively, when it is determined that the passenger 2 is in the unstable posture while the vehicle 10 is stopped, the vehicle safety apparatus maintains the stop of the vehicle 10. That is, the vehicle safety apparatus suspends the departure of the vehicle 10 while the passenger 2 is in the unstable posture. Thus, by performing the motion control of the vehicle 10 in accordance with the riding posture of the passenger 2, it is possible to increase the safety when the passenger 2 is in an unstable posture.

### 1-2. Schematic Structure of Vehicle According to Present Embodiment

Next, a schematic structure of a vehicle to which the vehicle safety apparatus according to the present embodiment is applied will be described with reference to FIG. 1. The vehicle 10 according to the present embodiment is a small autonomous traveling vehicle having a pallet-type vehicle body. The vehicle 10 is a low-floor vehicle whose height of a deck 4 is about 30 cm from the ground. The lower part of the vehicle 10 has a plurality of wheels 12 on each side. These wheels 12 allow the vehicle 10 to travel in either direction, left or right in FIG. 1. However, here, the left direction as indicated by the arrows in FIG. 1 as the basic traveling direction of the vehicle 10. Then, the traveling direction is defined as the front of the vehicle 10, the opposite direction is defined as the rear of the vehicle 10.

Support posts 6 are erected at the front and rear of the deck 4 on each side. A beam 8 is stretched between the left and right support posts 6 in the front. Similarly, the beam 8 is stretched between the left and right support posts 6 in the rear. The beams 8 can be used as a seat, backrest or handrail for the passenger 2 on the deck 4.

The vehicle 10 is provided with internal sensors for monitoring a passenger 2 riding on the deck 4. The internal sensors includes one or more internal cameras 20. The one or more internal cameras 20 are provided inside each support post 6 to capture the entire body of the passenger 2 riding on the deck 4 of the vehicle 10 from the right front, left front, right rear, and left rear.

### 1-3. Configuration of Control System of Vehicle According to Present Embodiment

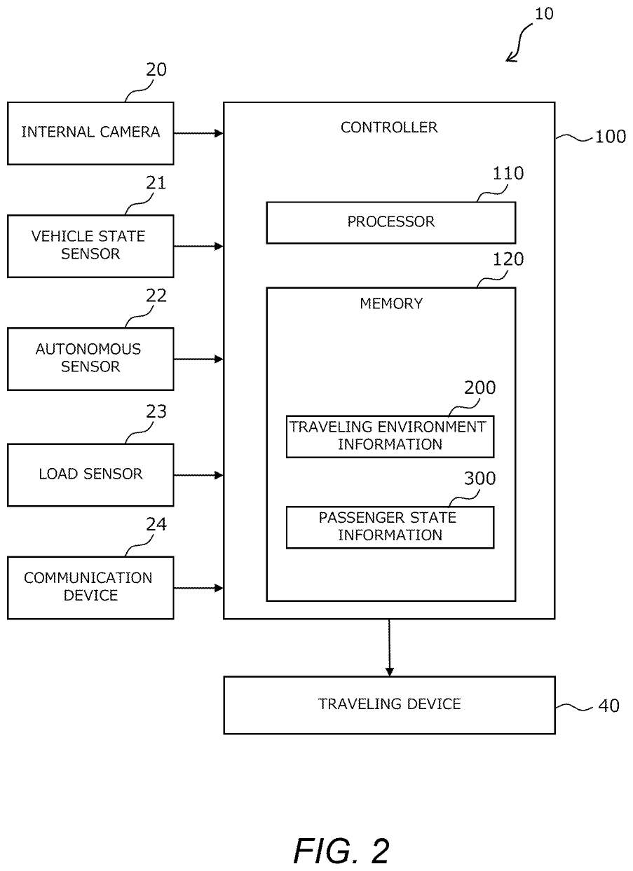

Next, a configuration of a control system of the vehicle 10 to which the vehicle safety apparatus is applied will be described with reference to FIG. 2. FIG. 2 is a block diagram for explaining a schematic configuration of a control system of a vehicle according to the present embodiment. The vehicle 10 is provided with a number of sensors to acquire information necessary for realizing autonomous driving. For example, a vehicle state sensor 21 for acquiring information about the motion state of the vehicle, such as a wheel speed sensor and an acceleration sensor, is mounted on the vehicle 10. The vehicle 10 is also equipped with autonomous sensors 22 that acquire information about the surrounding environment of the vehicle, such as external cameras, millimeter-wave radar, and LIDAR (Laser Imaging Detection and Ranging). Further, a load sensor 23 is installed inside the deck 4 of the vehicle 10. The load sensor 23 is used to measure the weight of the passenger on the vehicle 10. Further, the vehicle 10 is equipped with a communication device 24 for communicating between the vehicle and the outside, such as a GPS unit for detecting the position of the vehicle on the map, a mobile communication unit for performing mobile communication with a server on the Internet, and a wireless communication unit for performing wireless communication with a surrounding person, an object, or a facility.

The above-described internal camera 20, the sensors 21, 22, 23 and the communication device 24 are connected to a controller 100. The controller 100 includes one or more ECUs (Electronic Control Unit) and includes at least one processor 110 and at least one memory 120. The memory 120 described herein also includes storage. A program for automated driving is stored in the memory 120. Map information for automated driving is stored in the memory 120 in the form of a database, or is retrieved from a database in a server and temporarily stored in the memory 120.

A traveling device 40 for operating the wheel 12 is mounted in the vehicle 10. The traveling device 40 is a motor provided independently on each of the wheels 12. The wheels 12 are each driven by an independent motor and are capable of rotating at independent speeds and directions. Specifically, the middle wheels of the wheels 12 are normal wheels, while the front and rear wheels are omni wheels. The controller 100 controls the operation of the traveling device 40 to cause the vehicle 10 to travel along the target path. Further, the controller 100 controls the operation of the traveling device 40 so as to decelerate or stop the vehicle 10 when the vehicle is operated as a vehicle safety apparatus.

Further, the processor 110 acquires driving environment information 200 indicating the driving environment of the vehicle 10. The driving environment information 200 is acquired based on the detection result by the vehicle state sensor 21 and the autonomous sensor 22 mounted on the vehicle 10. The driving environment information 200 includes vehicle position information, vehicle state information, surrounding circumstance information, and map information.

The vehicle position information is information indicating the position and orientation of the vehicle 10 in the absolute coordinate system. The vehicle state information is information indicating the state of the vehicle 10. As the state of the vehicle 10, a vehicle speed, a yaw rate, a lateral acceleration, and the like are exemplified. The processor 110 acquires the vehicle state information from the detection result by the vehicle state sensor 21. The surrounding circumstance information is information indicating the surrounding situation of the vehicle 10. The surrounding circumstance information includes information obtained by the autonomous sensor 22. For example, the surrounding circumstance information includes image information indicative of a situation around the vehicle 10 imaged by an external camera. As another example, ambient situation information includes metrological information measured by millimeter-wave radar or lidar. The map information indicates a lane layout, a road shape, and the like. The acquired operating environment information 200 is stored in the memory 120.

Further, the processor 110 acquires passenger state information 300 indicating the information of the passenger 2 who has boarded the vehicle 10. The passenger state information 300 includes image information of the passenger 2 captured by the internal camera 20. The passenger state information 300 also includes information on the weight of the passenger detected by the load sensor 23. The acquired information is stored in the memory 120.

### 1-4. Function of Controller According to Present Embodiment

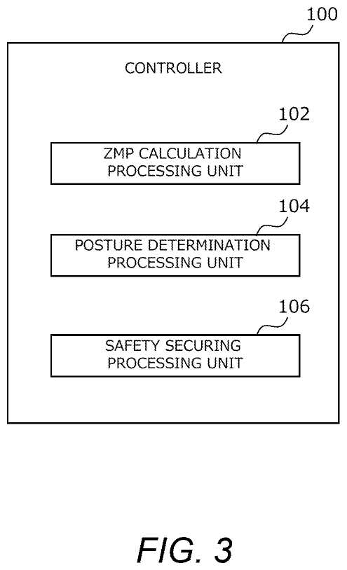

Next, the function of the controller 100 will be described. FIG. 3 is a block diagram for explaining functions realized by the controller of the present embodiment. The controller 100 includes a ZMP calculation processing unit 102, a posture determination processing unit 104, and a safety securing processing unit 106, as shown in a block in FIG. 3. However, these processing units do not exist as hardware. The controller 100 is programmed to perform the functions of the vehicle safety apparatus shown in block in FIG. 3. More specifically, when a program stored in the memory 120 is executed by the processor 110, the processor 110 executes processing related to these processing units. The controller 100 has various functions for automated driving in addition to the functions of the vehicle safety apparatus shown in block in FIG. 3. However, since known techniques can be used for automated driving, the description is omitted in this specification. Hereinafter, the processing of the function of the vehicle safety apparatus will be described in detail.

### 1-4-1. ZMP Calculation Processing

The processor 110 as the ZMP calculation processing unit 102 executes ZMP calculation processing for calculating the ZMP for each of the one or the plurality of passengers 2 riding on the vehicle 10. In the ZMP calculation processing, the processor 110 reads image information including the entire body of the passenger 2 captured by the internal camera 20 from the passenger state information 300 stored in the memory 120.

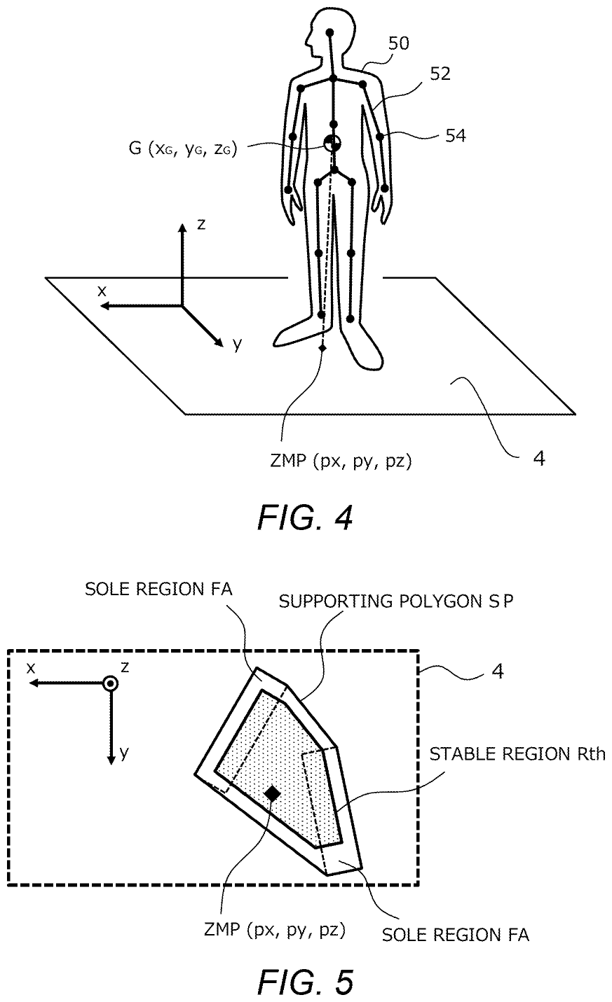

FIG. 4 is a diagram showing an example of a whole-body image of a passenger used for calculation of ZMP. In the following ZMP calculation processing, the traveling direction of the vehicle 10 (longitudinal direction) is defined as the X direction, the left-right direction of the vehicle 10 is defined as the Y direction, and the up-down direction of the vehicle 10 is defined as the Z direction. Further, the Z direction, the surface of the deck 4 is 0, the sign is defined upward as “positive”. The processor 110 acquires skeleton data information 52 and indirect position information 54 by performing known image analysis on a whole-body image 50 of the passenger 2. The processor 110 calculates the position of the center of gravity of the passenger 2 by using the following equation (1).

For the calculation of the position of the center of gravity, for example, a calculation model represented by the following equation (1) is used. In the following equation (1), the weight M of the passenger 2, the number N of the body segments, the coordinates (xi, yi, zi) of the i-th body segment, and the center of gravity coordinate G (xG, yG, zG) of the passenger 2 are calculated from the mass mi of the i-th body segment. The mass M may use the weight of the passenger detected by the load sensor 23 from among the passenger state information 300. Alternatively, the mass M may use a body weight estimated from the whole-body image 50. The mass mi of the i-th body segment is a body part instantaneous coefficient (BSP) pre-stored in the memory 120 is used.

$${x}_{G} = \frac{{\sum }_{i = 1}^{N} {m}_{i} {x}_{i}}{M} \\ {y}_{G} = \frac{{\sum }_{i = 1}^{N} {m}_{i} {y}_{i}}{M} \\ {z}_{G} = \frac{{\sum }_{i = 1}^{N} {m}_{i} {z}_{i}}{M} \qquad ( 1 )$$

The processor 110 then calculates the acceleration (xG″, yG″, zG″) of the center of gravity of the passenger 2 using the following equation (2). In the following equation (2), t is the time and T is the sampling time.

$${x}_{G}^{″} = \frac{{x}_{G} ( t + 2 ) - 2 {x}_{G} ( t + 1 ) + {x}_{G} ( t )}{{T}^{2}} \\ {y}_{G}^{″} = \frac{{y}_{G} ( t + 2 ) - 2 {y}_{G} ( t + 1 ) + {y}_{G} ( t )}{{T}^{2}} \\ {z}_{G}^{″} = \frac{{z}_{G} ( t + 2 ) - 2 {z}_{G} ( t + 1 ) + {z}_{G} ( t )}{{T}^{2}} \qquad ( 2 )$$

Next, the processor 110 calculates ZMP (px, py, pz) of the passenger 2 using the following equation (3). In the following equation (3), g is the gravitational acceleration. The calculated ZMP is stored in the memory 120 as part of the passenger state information 300.

$${p}_{x} = {x}_{G} - \frac{{z}_{G}}{{z}_{G}^{″} + g} {x}_{G}^{″} \\ {p}_{y} = {y}_{G} - \frac{{z}_{G}}{{z}_{G}^{″} + g} {y}_{G}^{″} \\ {p}_{z} = 0 \qquad ( 3 )$$

### 1-4-2. Posture Determination Processing

The processor 110 as the posture determination processing unit 104 executes the posture determination processing for determining whether the riding posture is stable for each of the one or a plurality of passengers 2 riding on the vehicle 10. In the posture determination processing, the processor 110 determines whether the ZMP calculated by the ZMP calculation processing belongs to a predetermined stable region Rth. The stable region Rth is a ZMP range in which the posture can be maintained against shaking or the like caused by the traveling of the vehicle 10. FIG. 5 is a diagram showing an example of the stable region Rth of ZMP. As shown in FIG. 5, the stable region Rth can be set, for example, in a region inside a supporting polygon SP determined from a sole region FA of the passenger 2. Specifically, the processor 110 reads an image including the foot of the passenger 2 captured by the internal camera 20 from the passenger state information 300 stored in the memory 120. Next, the processor 110 calculates the sole region FA of the passenger 2 by using a known image analysis method to calculate the supporting polygon SP. Then, the processor 110 calculates, for example, a region obtained by offsetting the supporting polygon SP inward by a predetermined ratio as the stable region Rth. The method of calculating the stable region Rth is not limited to the above. That is, the stable region Rth may be calculated by another method as long as the stable region Rth is included in the inner region of the supporting polygon SP.

### 1-4-3. Safety Securing Processing

The processor 110 as the safety securing processing unit 106 executes safety securing processing for decelerating or stopping the vehicle 10 when the riding posture of at least one of the one or plural passengers 2 riding on the vehicle 10 is not stable. In the safety securing processing, when the ZMP of the passenger 2 calculated by the ZMP calculation processing does not belong to the stable region Rth, the processor 110 performs the motion control of the vehicle 10 for securing the safety of the passenger 2. Specifically, the processor 110 controls the traveling device 40 to decelerate or stop the vehicle 10 when the vehicle 10 is traveling. Alternatively, the processor 110 controls the traveling device 40 to maintain a stop of the vehicle 10 and suspend starting, when the vehicle 10 is stopped.

### 1-5. Operation Procedure of Vehicle Safety Apparatus

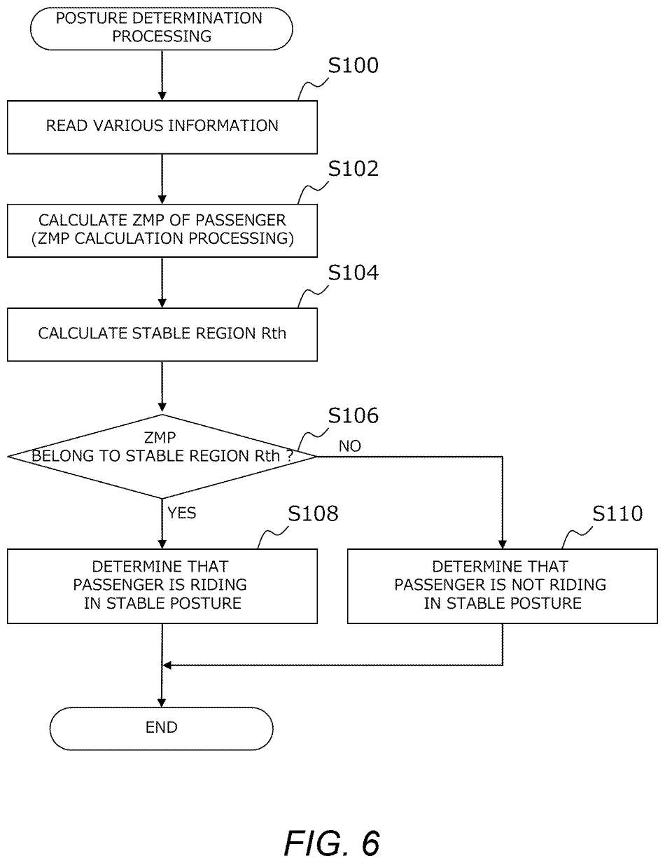

The controller 100 in which the functions of the vehicle safety apparatus described above are programmed executes the ZMP calculation processing, the posture determination processing, and the safety securing processing in the following procedure while the passenger 2 is riding on the vehicle 10. FIG. 6 is a flowchart of a routine in which the controller executes the ZMP calculation processing and the posture determination processing. The routine shown in FIG. 6 is repeatedly executed at a predetermined control cycle during a period in which the passenger 2 is riding on the vehicle 10.

In step S100, the processor 110 reads various information from the memory 120. The information includes, for example, the driving environment information 200 and the passenger state information 300. In the next step S102, the ZMP of each of the one or more passengers 2 riding on the vehicle 10 is calculated. Here, the processor 110 executes the ZMP calculation processing described above using the various information read in the step S100.

In the next step S104, the stable region Rth is calculated using the various information read in the step S100. Here, the processor 110 calculates the stable region Rth by the posture determination processing described above.

In the next step S106, it is determined whether the ZMP calculated in the step S102 belongs to the stable region Rth calculated in the step S104. Here, the processor 110 compares the calculated ZMP with the stable region Rth by the posture determination processing described above. As a result, when it is determined that the ZMP belongs to the stable region Rth, the process proceeds to step S108, and when it is determined that the ZMP does not belong to the stable region Rth, the process proceeds to step S110.

In the step S108, it is determined that the passenger 2 is riding in the stable posture, and a posture determination processing result as a result of the determination is stored in the memory 120. On the other hand, in the step S110, it is determined that the passenger 2 is not riding in the stable posture, and the posture determination processing result as a result of the determination is stored in the memory 120.

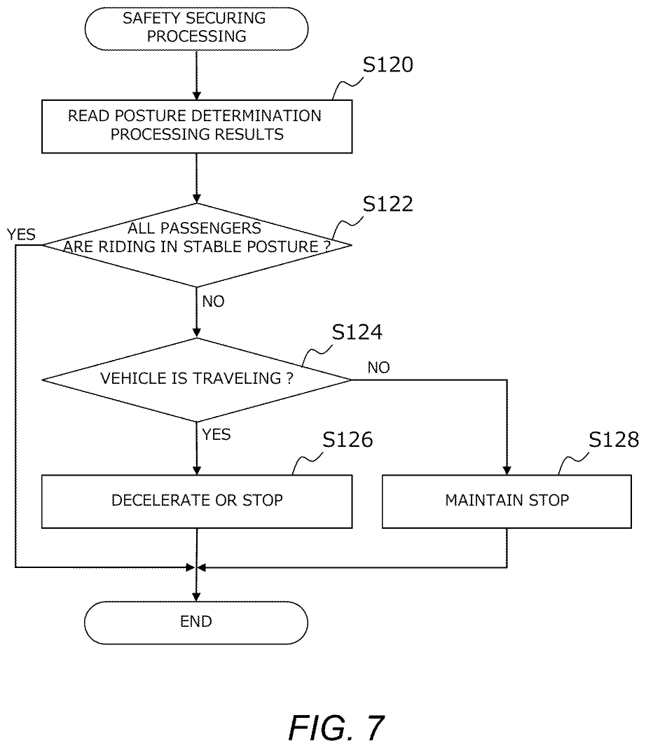

FIG. 7 is a flowchart of a routine in which the controller executes the safety securing processing. The routine shown in FIG. 7 is repeatedly executed at a predetermined control cycle during a period in which the passenger 2 is riding on the vehicle 10. In step S120, the processor 110 reads the posture determination processing results of one or more of the passengers 2 from the memory 120. In the next step S122, the processor 110 determines whether all the passengers 2 are riding in the stable posture based on the read posture determination processing result. As a result, when it is determined that the determination is satisfied, it is determined that the motion control of the vehicle 10 for securing safety is not necessary, and the routine is terminated.

On the other hand, when the determination is not satisfied in the determination of step S122, it is determined that the motion control of the vehicle 10 for ensuring safety is required. Then, the process proceeds to the next step S124. In the step S124, it is determined whether the vehicle 10 is traveling. Consequently, when the vehicle 10 is traveling, the process proceeds to step S126, and when the vehicle 10 is not traveling, the process proceeds to step S128.

In the step S126, the processor 110 controls the traveling device 40 such that the vehicle 10 in travel decelerates or stops. Further, in the step S128, the processor 110 controls the traveling device 40 so that the stopped vehicle 10 maintain the stop. When the process of step S126 or step S128 is completed, the routine is terminated.

According to the vehicle safety apparatus of the present embodiment, based on the riding posture of one or more passengers 2 riding on the vehicle 10, the motion control of the vehicle 10 is performed. This makes it possible to secure the safety of the riding passenger.

### 1-6. Modified Examples

The vehicle safety apparatus of the first embodiment may be modified as follows.

The vehicle 10 on which the vehicle safety apparatus is mounted is not limited to the pallet-type small mobility vehicle, as long as the vehicle is designated to be ridden standing by passengers. Further, the vehicle 10 is not limited to a driverless vehicle capable of autonomous traveling, it can be widely applied to a vehicle requiring a driver.

In the step S126, the processor 110 may provide notification to the passenger 2 in addition to motion control of the vehicle 10. Incidentally, the notification here, for example, voice notification or display prompting a stable posture with respect to the passenger 2, voice notification or display indicating that the vehicle 10 performs deceleration or stop, etc. are exemplified. Therefore, the passenger 2 can grasp that the deceleration or stop of the vehicle 10 is performed due to its own riding posture.

### 2. Second Embodiment

### 2-1. Features of Second Embodiment

It can be said that the riding posture is stable when the passenger 2 standing on the vehicle 10 is grasping the beam 8 or the support post 6 of the vehicle 10, or when the beam 8 is utilized for sitting or leaning. Therefore, the vehicle safety apparatus of the second embodiment determines that the passenger 2 is riding in a stable posture, when the passenger 2 standing on the vehicle 10 is supported by a fixed object of the vehicle 10. According to such control, it is possible to suppress the deceleration or stop of the unnecessary vehicle 10 is performed.

### 2-2. Operation Procedure of Posture Determination Processing of Second Embodiment

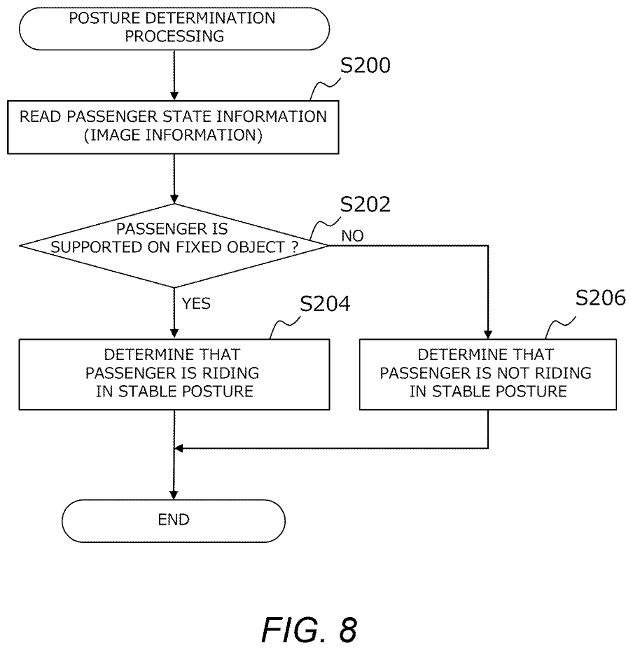

FIG. 8 is a flowchart of a routine in which the controller according to the second embodiment executes the posture determination processing. The routine shown in FIG. 8 is repeatedly executed at a predetermined control cycle during a period in which the passenger 2 is riding on the vehicle 10.

In step S200, the processor 110 reads various information from the memory 120. The information includes passenger state information 300. In the next step S202, the processor 110 determines whether the passenger 2 is supported on a fixed object of the vehicle 10. For example, based on the image information of the passenger 2 included in the passenger state information 300, it is determined whether the passenger 2 is grasping or leaning on the beam 8 or the support post 6. As a result, when the determination is confirmed, the process proceeds to step S204, and when the determination is not confirmed, the process proceeds to step S206.

In the step S204, it is determined that the passenger 2 is riding in the stable posture, and a posture determination processing result as a result of the determination is stored in the memory 120. On the other hand, in the step S206, it is determined that the passenger 2 is not riding in the stable posture, and the posture determination processing result as a result of the determination is stored in the memory 120.

According to the vehicle safety apparatus of the second embodiment, when the passenger 2 riding on the vehicle 10 is supported by the fixed object of the vehicle 10, it is determined that riding in a stable posture. This makes it possible to suppress unnecessary decelerating or stop of the vehicle 10.

### 2-3. Modified Examples

The vehicle safety apparatus of the second embodiment may be modified as follows.

The posture determination processing of the second embodiment described above may be executed in combination with the posture determination processing executed by the vehicle safety apparatus of the first embodiment. For example, when the passenger 2 is determined to be supported by the fixed object of the vehicle 10, than when not supported, it may be set wider stable region is a threshold of ZMP. In this case, for example, in the step S104 described above, the determination of the step S202 is performed, and when the determination is established, the stable region may be set wider than in the case where it is not recognized.

Alternatively, the process may proceed to the process of step S108 when the determination of step S202 is confirmed, and the process may proceed to the process of step S102 when the determination of step S202 is not confirmed. According to such control, when the passenger 2 is not supported by the fixed object, the posture determination processing based on the ZMP is further performed. Thus, it is not determined that it is not uniformly stable posture when the fixed object such as the beam 8 is not gripped, since it is determined whether or not the stable posture by the posture determination processing based on the further ZMP, it is possible to reduce the erroneous determination of the riding posture.

The determination of step S202 is not limited to the method of determining using the image information of the passenger 2. That is, in the step S202, for example, the sensor may directly detect whether the fixed object is touched. In this case, a contact sensor for detecting contact is mounted on the fixed object such as the beam 8, and contact presence information, which is a detection result of the contact sensor, is stored in the memory 120 as the passenger state information 300. Then, the processor 110 reads the contact presence/absence information included in the passenger state information 300 in step S200, and determines whether the passenger 2 is supported by the fixed object of the vehicle 10 based on the contact presence/absence information in step S202.

### 3. Third Embodiment

### 3-1. Features of Third Embodiment

In the case where the face of the passenger 2 standing on the vehicle 10 has a surprising facial expression or an anxious facial expression, there is a higher possibility that some situation has occurred, such as the riding posture being unstable, than in the case where the face has a reassuring facial expression. Therefore, the vehicle safety apparatus of the third embodiment determines the riding posture in accordance with the facial expression of the passenger 2 standing on the vehicle 10. Specifically, when the passenger 2 has a reassuring facial expression, it is determined that the passenger 2 is riding in the stable posture. On the other hand, when the passenger 2 has a surprising facial expression or an anxious facial expression, it is determined that the passenger 2 is not riding in the stable posture. According to such control, it is possible to increase the safety of the passenger 2 riding on the vehicle 10.

### 3-2. Operation Procedure of Posture Determination Processing According to Third Embodiment

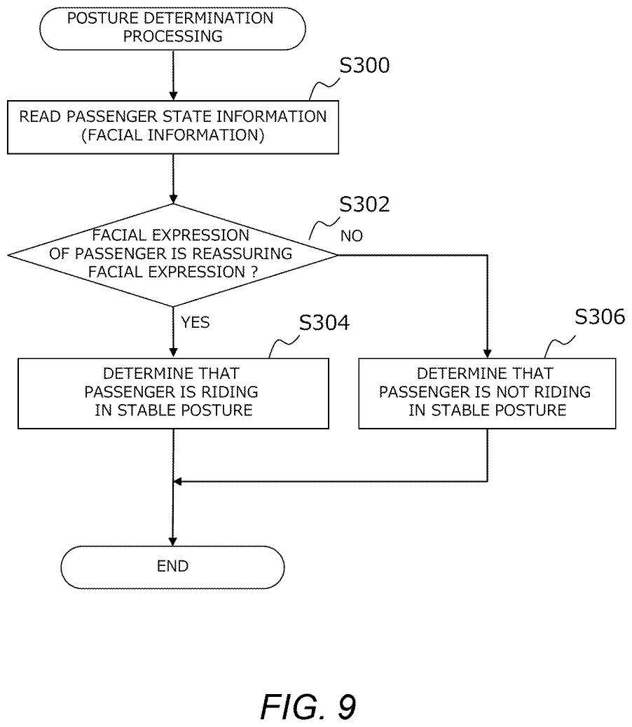

FIG. 9 is a flowchart of a routine in which the controller according to the third embodiment executes the posture determination processing. The routine shown in FIG. 9 is repeatedly executed at a predetermined control cycle during a period in which the passenger 2 is riding on the vehicle 10.

In step S300, the processor 110 reads various information from the memory 120. The information includes passenger state information 300. In the next step S302, the processor 110 determines whether the facial expression of the passenger 2 is a reassuring facial expression based on the facial information of the passenger 2 included in the passenger state information 300. Here, using a known image analysis technique, the facial expression of the passenger 2 is analyzed to classify whether it is a comfortable facial expression or a fear or surprise facial expression. As a result, when the facial expression of the passenger 2 is classified as a secure facial expression, the process proceeds to step S304, and when the facial expression of the passenger 2 is classified as an anxiety or surprise facial expression, the process proceeds to step S306.

In the step S304, it is determined that the passenger 2 is riding in the stable posture, and the posture determination processing result as a result of the determination is stored in the memory 120. On the other hand, in the step S306, it is determined that the passenger 2 is not riding in the stable posture, and the posture determination processing result as a result of the determination is stored in the memory 120.

As described above, according to the vehicle safety apparatus of the third embodiment, it is possible to determine the riding posture based on the facial expression of the passenger 2 riding on the vehicle 10.

### 3-3. Modified Examples

The vehicle safety apparatus of the third embodiment may be modified as follows.

The posture determination processing of the third embodiment described above may be executed in combination with the posture determination processing executed by the vehicle safety apparatus of the first embodiment. For example, when the passenger 2 is determined to be a secure expression, than when it is an expression of anxiety or surprise, it may be set wider stable region is a threshold value of ZMP. In this case, for example, in the above-described step S104, the determination of the step S302 is executed, and when the determination is established, the stable region may be set wider than when the determination is not established.

Alternatively, the process may proceed to the process of step S108 when the determination of step S302 is confirmed, and the process may proceed to the process of step S102 when the determination of step S302 is not confirmed. According to such control, when the facial expression of the passenger 2 is not a reassuring facial expression, the posture determination processing based on the ZMP is further performed. This makes it possible to reduce erroneous determination of the riding posture, since it is determined whether the vehicle is in the stable posture by further posture determination processing based on ZMP, instead of uniformly determining that the vehicle is not in the stable posture when the vehicle is in a state of anxiety or surprise.

### 4. Fourth Embodiment

### 4-1. Features of Fourth Embodiment

For example, when the passenger 2 standing on the vehicle 10 is like standing one foot, even if ZMP belongs to the stable region, it may be changed to an unstable posture by shaking or the like of the vehicle 10. Further, when the passenger 2 is leaning out of the vehicle 10, the passenger 2 may not be in a stable position, even when grasping the fixed object of the vehicle 10. Therefore, the vehicle safety apparatus of the fourth embodiment visually determines whether the riding posture is stable based on the image information obtained by capturing the riding posture of the passenger 2 standing on the vehicle 10.

### 4-2. Operation Procedure of Posture Determination Processing of Fourth Embodiment

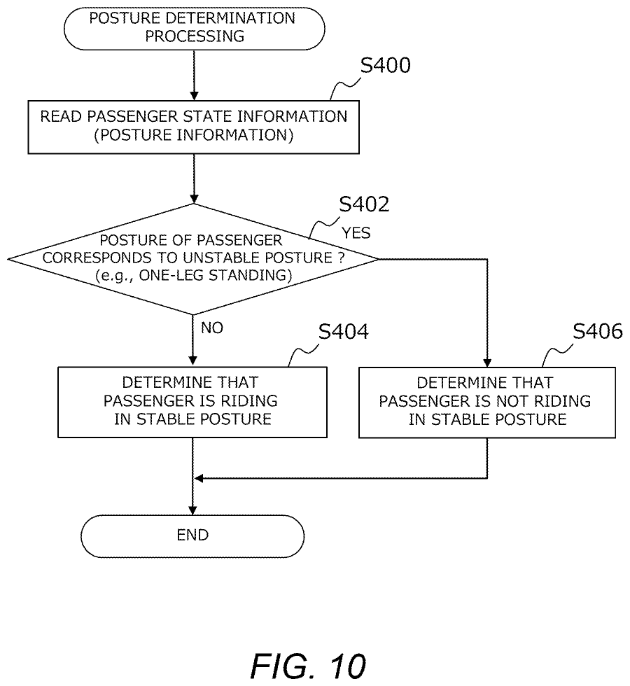

FIG. 10 is a flowchart of a routine in which the controller according to the fourth embodiment executes the posture determination processing. The routine shown in FIG. 10 is repeatedly executed at a predetermined control cycle during a period in which the passenger 2 is riding on the vehicle 10.

In step S400, the processor 110 reads the passenger state information 300 from the memory 120. The passenger state information 300 includes the posture information obtained by capturing an image of the posture of the passenger. In the next step S402, the processor 110 determines whether the posture of the passenger 2 is stable based on the posture information of the passenger 2 included in the passenger state information 300. Here, it is determined whether the posture of the passenger 2 included in the posture information corresponds to the image pattern of the predetermined unstable posture, such as one-leg standing, a posture riding the body outside the vehicle, and the like. As a result, when it is determined that the posture of the passenger 2 is the stable posture, the process proceeds to step S404, and the posture determination processing result, which is the result of the determination, is stored in the memory 120. On the other hand, when it is determined that the posture of the passenger 2 is an unstable posture, the process proceeds to step S406, and the posture determination processing result, which is the result of the determination, is stored in the memory 120.

As described above, according to the vehicle safety apparatus of the fourth embodiment, it is possible to determine the riding posture based on the posture information of the passenger 2 riding on the vehicle 10.

### 4-3. Modified Examples

The vehicle safety apparatus of the fourth embodiment may be modified as follows.

The posture determination processing of the fourth embodiment described above may be executed in combination with the posture determination processing executed by the vehicle safety apparatus of the first embodiment. For example, when it is determined that the passenger 2 is in the stable posture, the stable region, which is the threshold value of ZMP, may be set wider than in the case of the unstable posture. In this case, for example, in the step S104 described above, the determination of the step S402 is performed, and when the determination is established, the stable region may be set wider than in the case where it is not recognized.

Alternatively, the process may proceed to the process of step S108 when the determination of step S402 is confirmed, and the process may proceed to the process of step S102 when the determination of step S402 is not confirmed. According to such control, when the posture of the passenger 2 determined from the posture information is stable, the posture determination processing based on the ZMP is further performed. Thereby, even when it is determined that the vehicle is in the stable posture based on the posture information, it is determined whether the vehicle is in the stable posture by the posture determination processing based on the further ZMP, so that it is possible to reduce erroneous determination of the vehicle riding posture.

What is claimed is:

1. A vehicle safety apparatus mounted on a vehicle comprising:
one or more cameras to detect passenger state information relating to a riding state of a passenger on the vehicle;
a memory to store the passenger state information detected by the one or more cameras; and
a processor to execute motion control of the vehicle based on the passenger state information stored in the memory,
wherein, the processor is configured to execute:
posture determination processing to determine whether the passenger is riding in a stable posture based on the passenger state information, and
safety securing processing to secure safety of the passenger by executing the motion control, when the passenger is not riding in the stable posture in the posture determination processing.

2. The vehicle safety apparatus according to claim 1,
wherein, the posture determination processing includes:
a process of calculating a zero moment point of the passenger based on the passenger state information, and
a process of determining whether the passenger is riding in the stable posture based on the zero moment point.

3. The vehicle safety apparatus according to claim 1,
wherein, the posture determination processing includes:
a process of determining whether the passenger is supported by a fixed object of the vehicle based on the passenger state information, and
a process of determining that the passenger is riding in the stable posture when the passenger is determined to be supported by the fixed object.

4. The vehicle safety apparatus according to claim 1,
wherein, the safety securing processing includes stopping or decelerating while the vehicle travels, or suspending starting while the vehicle is stopped.

5. The vehicle safety apparatus according to claim 1,
wherein, the passenger state information includes facial information relating to facial expressions of the passenger, and
wherein, the posture determination processing includes a process of determining whether the passenger is riding in the stable posture based on the facial information.

6. The vehicle safety apparatus according to claim 1,
wherein, the passenger state information includes posture information related to a posture of the passenger, and
wherein, the posture determination processing includes a process of determining whether the passenger is riding in the stable posture based on the posture information.
